(19) United States
(12) Patent Application Publication
(10) Pub. No.: US 2012/0101623 A1
(43) Pub. Date: Apr. 26, 2012

(54) Encryption Method of Digital Data, Decryption Method of Encrypted Digital Data, Manufacturing System of Storage Apparatus and Manufacturing Method Thereof

(75) Inventors: Chung-Chien Hwang, Hsinchu City (TW); Shi-Jie Wu, Hsinchu City (TW)

(73) Assignee: BEST WISE INTERNATIONAL COMPUTING CO., LTD., Hsinchu City (TW)

(21) Appl. No.: 13/277,832

(22) Filed: Oct. 20, 2011

Related U.S. Application Data
(60) Provisional application No. 61/405,647, filed on Oct. 22, 2010.

(51) Int. Cl. G06F 19/00; H04L 9/06

(52) U.S. Cl. 700/117; 380/44

(57) ABSTRACT

An encryption method of digital data, a decryption method of encrypted digital data, a manufacturing system of storage apparatus and a manufacturing method thereof. The storage apparatus manufacturing method comprises the steps of: providing a plurality of first and second storage apparatuses having different first and second unique identifiers; generating first and second group IDs according to the first and second unique identifiers respectively, and generating first and second gold keys according to the first and second group IDs respectively by a processing module; encrypting first and second digital data according to the first and second gold keys to generate first and second encrypted digital data respectively; storing the first and second encrypted digital data into the first and second storage apparatuses; and packaging the first and the second storage apparatus to a plurality of packages randomly by a packaging module.

### RELATED APPLICATION

This application claims the benefit of co-pending U.S. provisional application 61/405,647, filed on Oct. 22, 2010, the entire specification of which is incorporated herein by reference.

### FIELD OF THE INVENTION

The present invention relates to an encryption method of digital data, a decryption method of encrypted digital data, a storage apparatus, a manufacturing system of the storage apparatus, and the manufacturing method of the storage apparatus, in particular to the encryption method of digital data that uses a unique identifier (UID) of the storage apparatus to encrypt the digital data, as well as the decryption method of the encrypted digital data, the storage apparatus, and the manufacturing system and method of the storage apparatus.

### BACKGROUND OF THE INVENTION

As science and technology, particularly network technologies advance, computers become an indispensable part of our life. We turn on the computer to read emails, handle official businesses, browse the Internet, use instant messages, and read articles, and the computers have a trend to replace traditional paper and books text to give rise of a revolution in the field of knowledge due to the popularity of the computer and the format of electronic and digital contents (such as ppt, pdf, wmv, and flash). For example, digital teaching solutions, e-books, and electronic schoolbags cannot be separated from electronic digital contents. Therefore, the protection of digital content becomes considerably important. As to content providers, most of the digital contents require protections, and any duplication and distribution are not acceptable.

However, present users reading protected contents generally need to communicate with the Internet in order to obtain the permission to access the contents. Under the environment without the need of using the Internet, a higher manufacturing cost will be incurred to the content providers and a time-consuming process will be required for encrypting the digital contents and manufacturing each portable device.

### SUMMARY OF THE INVENTION

In view of the aforementioned problems, it is a primary objective of the present invention to provide an encryption method, a decryption method of encrypted digital data, a storage apparatus, a manufacturing system of the storage apparatus and a manufacturing method of the storage apparatus, so as to overcome the problems of insufficient protection of the digital contents, wasting tremendous manufacturing time, and incurring a high cost.

To achieve the aforementioned objective, the present invention provides an encryption method of digital data, comprising the steps of: providing digital data, and reading a UID of a storage apparatus by a processing module and generating a group ID according to the UID, and generating an encryption key according to the group ID, and encrypting the digital data by the processing module according to encryption key to generate encrypted digital data, and finally storing the encrypted digital data into the storage apparatus.

Wherein, the processing module generates an encryption key by a hash algorithm (HASH), a message-digest algorithm (MD5) or a secure hash algorithm (SHA1).

Another objective of the present invention is to provide a decryption method of encrypted digital data, comprising the steps of: reading encrypted digital data in a storage apparatus by a processing module, and the encrypted digital data being encrypted by the aforementioned encryption method; reading a UID of the storage apparatus by the processing module, and generating a group ID according to the UID; generating a decryption key by the processing module according to the group ID; and decrypting the encrypted digital data according to the decryption key by the processing module to obtain and provide digital data.

Wherein, the processing module generates a decryption key by a hash algorithm (HASH), a message-digest algorithm (MD5) or a secure hash algorithm (SHA1).

Wherein, the decryption method of encrypted digital data further comprises the steps of using the processing module to detect whether or not the storage apparatus is electrically coupled to the processing module. If the processing module detects that the storage apparatus is not electrically coupled to the processing module, then the step of decrypting encrypted digital data according to the decryption key to obtain and provide digital data will not be executed.

Wherein, the decryption method of encrypted digital data further comprises the steps of: using the processing module to examine whether or not the storage apparatus is authenticated by a challenge-response protocol through a firmware of the storage apparatus; and if the storage apparatus is not authenticated, the processing module will not decrypt the encrypted digital data according to the decryption key to obtain and provide the digital data.

Another objective of the present invention is to provide a storage apparatus for storing the encrypted digital data, wherein after a processing module of the storage apparatus reads encrypted digital data and a UID of the storage apparatus, the processing module will generate a group ID according to the UID, and then generates a decryption key according to group ID, and decrypt encrypted digital data according to decryption key to obtain and provide digital data.

Wherein, the processing module generates the decryption key by a hash algorithm, a message-digest algorithm (MD5) or a secure hash algorithm (SHA1).

Wherein, the processing module further detects whether or not the storage apparatus is electrically coupled to the processing module, and if the processing module detects that the storage apparatus is not electrically coupled to the processing module, the processing module will not decrypt the encrypted digital data according to decryption key to obtain and provide digital data.

Wherein, the processing module further examines whether or not the storage apparatus is authenticated by a challenge-response protocol through a firmware of the storage apparatus; and if the storage apparatus is not authenticated, the processing module will not decrypt the encrypted digital data according to the decryption key to obtain and provide the digital data.

In addition, the present invention further provides a manufacturing method of a storage apparatus, and the method comprises the steps of: providing a plurality of first storage apparatuses, each of the first storage apparatuses having a different first UID; providing a plurality of second storage apparatuses, each of the second storage apparatuses having a different second UID; generating a first group ID according to the first UIDs by a processing module, and then generating a first encryption key according to the first group ID; using the processing module to generate a second group ID according to the second UIDs, and generating a second encryption key according to the second group ID; using the processing module to encrypt first digital data according to the first encryption key to generate first encrypted digital data; storing the first encrypted digital data into the first storage apparatuses; using the processing module to encrypt a second digital data according to the second encryption key to generate second encrypted digital data; storing the second encrypted digital data into the second storage apparatuses; and using a packaging module to package each first storage apparatus and each second storage apparatus randomly into a plurality of packages.

Wherein, the processing module generates the first encryption key and the second encryption key by a hash algorithm, a message-digest algorithm (MD5) or a secure hash algorithm (SHA1).

Wherein, the packaging module packages each of the first storage apparatuses and each of the second storage apparatuses is packaged into a plurality of packages by a shuffle method.

In addition, the present invention further provides a manufacturing system of a storage apparatus, comprising a production module, a processing module and a packaging module.

The production module provides a plurality of first storage apparatuses, and each of the first storage apparatuses has a different first UID, and the production module further provides a plurality of second storage apparatuses, and each of the second storage apparatuses has a different second UID. The processing module generates a first group ID according to the first UIDs, and then generates a first encryption key according to the first group ID and a second group ID according to the second UIDs, and then generates a second encryption key according to the second group ID, and then encrypts the first digital data according to the first encryption key to generate first encrypted digital data, and stores the first encrypted digital data into the first storage apparatuses, and further encrypts the second digital data according to the second encryption key to generate second encrypted digital data, and stores the second encrypted digital data into the second storage apparatuses. The packaging module disperses and assembles each of the first storage apparatuses and each the second storage apparatuses randomly into the plurality of packages.

Wherein, the processing module generates the first encryption key and the second encryption key by a hash algorithm, a message-digest algorithm (MD5) or a secure hash algorithm (SHA1).

Wherein, the packaging module packages each of the first storage apparatuses and each of the second storage apparatuses is packaged into a plurality of packages by a shuffle method.

In summation, the encryption method, the decryption method of encrypted digital data, the storage apparatus, the manufacturing system of the storage apparatus and the manufacturing method of the storage apparatus in accordance with the present invention have one or more of the following advantages:

(1) The encryption method, the decryption method of encrypted digital data, the storage apparatus, and the manufacturing system and the manufacturing method of the storage apparatus can encrypt information according to the unique identifier of the storage apparatus to improve the convenience of preventing unauthorized copy of the electronic contents.

(2) The encryption method, the decryption method of encrypted digital data, the storage apparatus, and the manufacturing system and the manufacturing method of the storage apparatus can encrypt information according to the key generated by the group ID, and package encrypted data randomly to overcome the problem of consuming lots of time for storing a large quantity of electronic data into the storage apparatus each time.

### BRIEF DESCRIPTION OF THE DRAWINGS

FIG. 1 is a flow chart of an encryption method of digital data in accordance with the present invention;

FIG. 2 is another flow chart of an encryption method of digital data in accordance with the present invention;

FIG. 3 is a flow chart of a decryption method of encrypted digital data in accordance with the present invention;

FIG. 4 is another flow chart of a decryption method of encrypted digital data in accordance with the present invention;

FIG. 5 is a schematic view of a storage apparatus in accordance with the present invention;

FIG. 6 is a block diagram of a manufacturing system of a storage apparatus in accordance with the present invention;

FIG. 7 is a schematic view of a manufacturing system of a storage apparatus in accordance with a preferred embodiment of the present invention; and

FIG. 8 is a flow chart of a manufacturing method of a storage apparatus in accordance with the present invention.

### DESCRIPTION OF THE PREFERRED EMBODIMENTS

The technical characteristics and effects of the present invention will become apparent by the detailed description of preferred embodiments and related drawings as follows. For simplicity, same numerals are used to represent respective elements in the preferred embodiment and drawings.

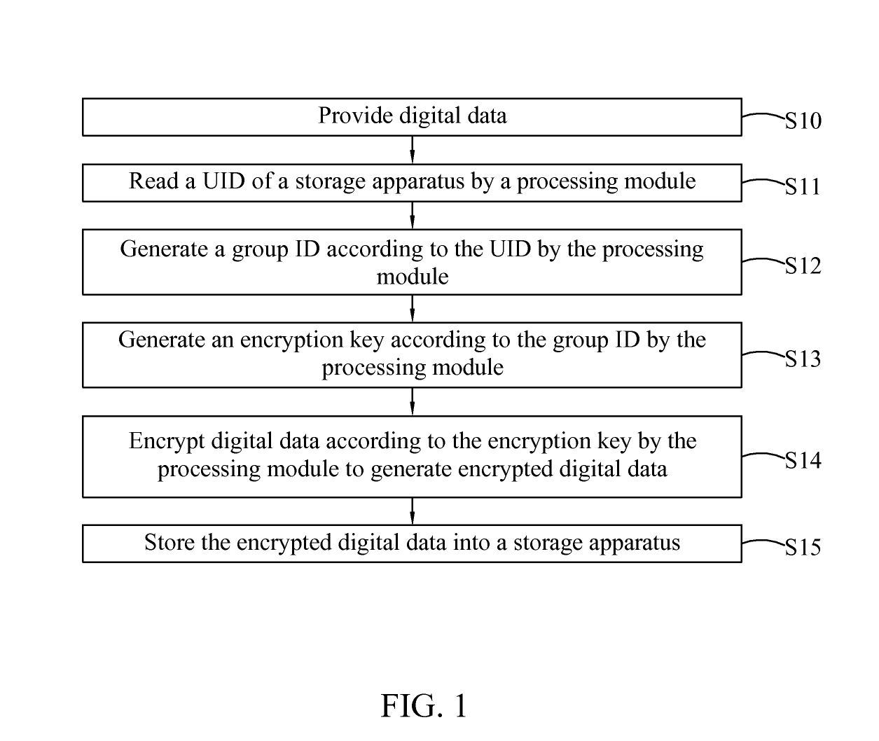

With reference to FIG. 1 for the flow chart of an encryption method of digital data in accordance with the present invention, the encryption method of digital data comprises the steps of:

(S10) providing digital data;

(S11) reading a unique identifier (UID) of a storage apparatus by a processing module;

(S12) generating a group ID by a processing module according to the UID;

(S13) generating an encryption key according to a group ID by the processing module;

(S14) encrypting digital data according to the encryption key by the processing module to generate encrypted digital data; and

(S15) storing the encrypted digital data into a storage apparatus.

In some preferred embodiments, the processing module can be a computer or a central processing unit (CPU), and the digital data can be in various audio, video, or text formats such as ppt, swf, pdf, doc, wma, wmv, mp3 or mp4, but the invention is not limited to these formats only.

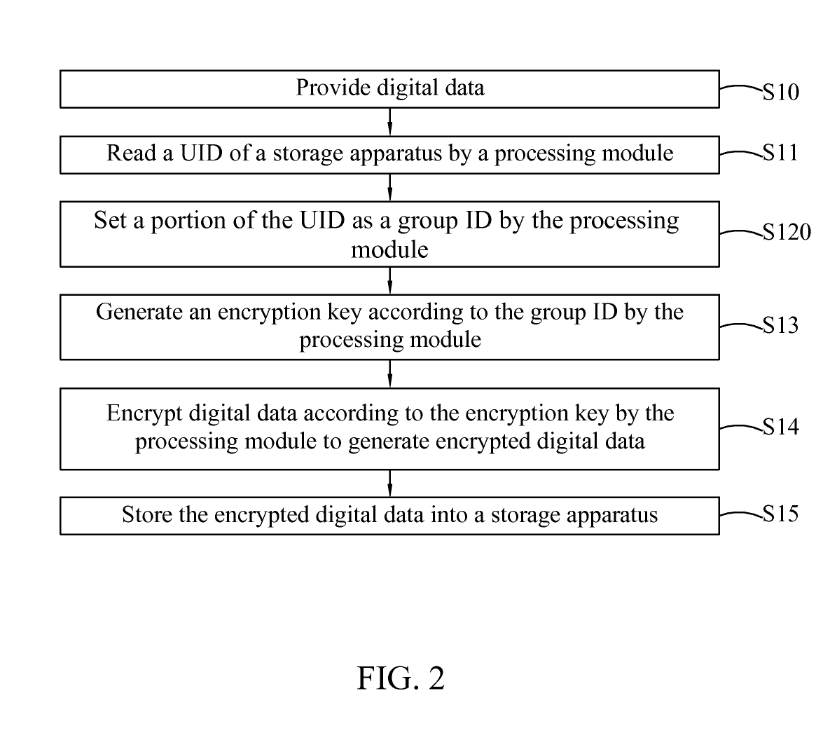

With reference to FIG. 2 for another flow chart of an encryption method of digital data in accordance with the present invention, the difference between the encryption method of this preferred embodiment and that of the aforementioned preferred embodiment resides on that the step (S12) of this preferred embodiment further comprises the steps of:

(S120) setting a portion of the UID as the group ID by the processing module.

However, the actual implementation is not limited to such arrangement only. In some preferred embodiments, the processing module can form the group ID according to certain digits such as the odd digits or even digits of the UID or different algorithms of the UID, and the storage apparatus is classified by the group ID. In addition, the processing module decrypts the group ID preferably by a hash algorithm (HASH), a message-digest algorithm (MD5) or a secure hash algorithm (SHA1) to generate an encryption key.

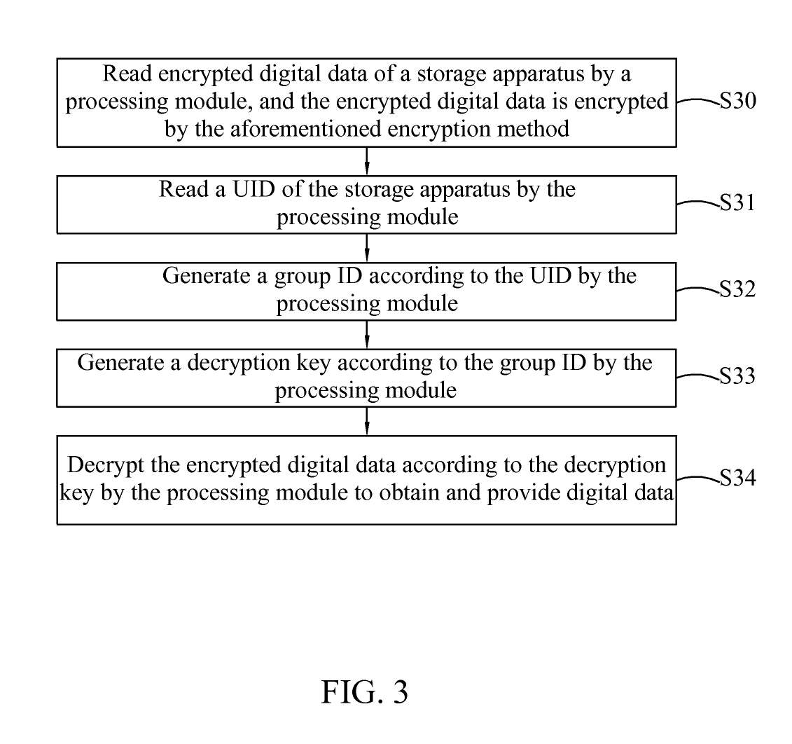

With reference to FIG. 3 for a flow chart of a decryption method of encrypted digital data in accordance with the present invention, the decryption method comprises the steps of:

(S30) reading encrypted digital data of a storage apparatus by a processing module, wherein the encrypted digital data is encrypted by the aforementioned encryption method;

(S31) reading a UID of the storage apparatus by the processing module;

(S32) generating a group ID according to the UID by the processing module;

(S33) generating a decryption key according to the group ID by the processing module; and

(S34) decrypting the encrypted digital data according to the decryption key by the processing module to obtain and provide digital data.

In some preferred embodiments, the processing module sets a portion of the UID as the group ID. However, the actual implementation is not limited to such arrangement only. In some preferred embodiments, the processing module further forms a group ID according certain digits such as the odd digits or even digits of the UID, or according to various algorithms applied to the UID. In addition, the processing module generates the decryption key by a hash algorithm (HASH), a message-digest algorithm (MD5) or a secure hash algorithm (SHA1). However, the actual implementation is not limited to such arrangement only.

In the foregoing encryption and decryption methods, and the process of using the group ID used as a decryption key, only a portion of the device's UID is taken as a basis of forming the key, so that the decryption keys required for the encrypted digital data stored in the storage apparatuses are the same in some patches of the storage apparatuses. If the decryptions keys are allocated to different points of sales randomly, the chance for the same person to obtain the same key can be reduced substantially, so as to reduce the manufacturing time and cost.

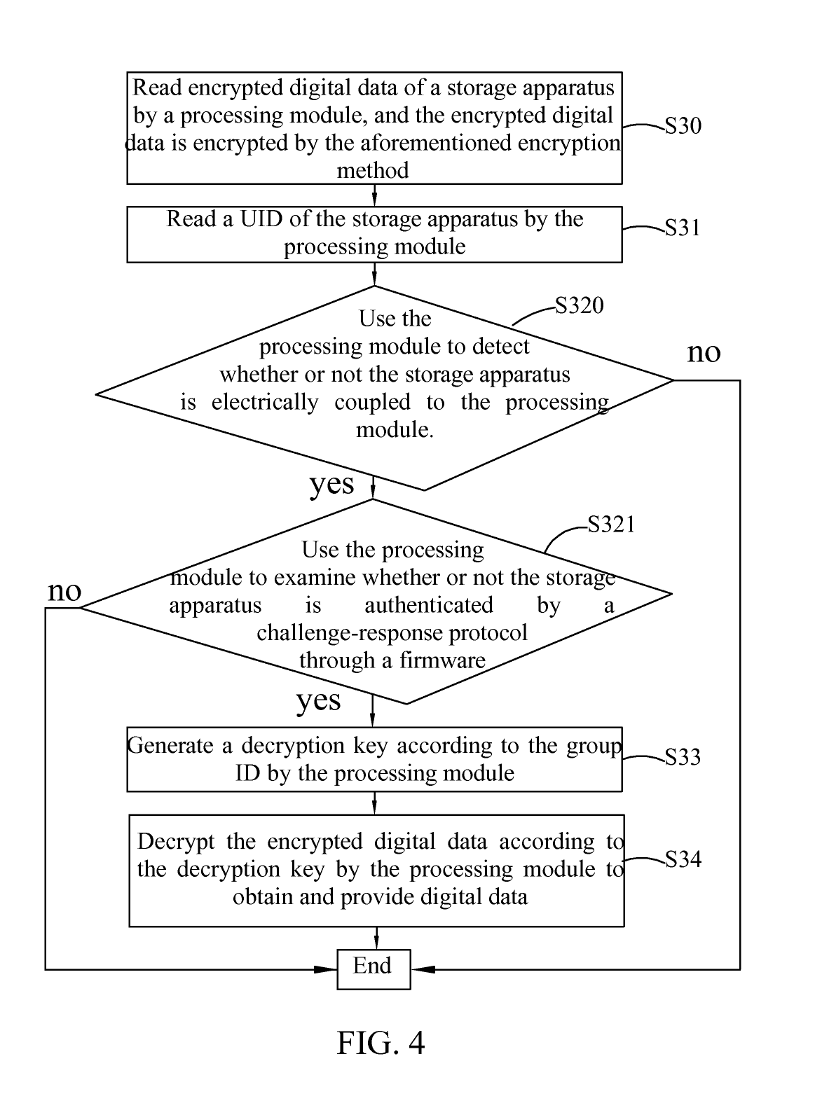

With reference to FIG. 4 for another flow chart of a decryption method of encrypted digital data in accordance with the present invention, the difference between this preferred embodiment and the foregoing preferred embodiment resides on that the following steps are included before the step (S33) takes place.

(S320) Use the processing module to detect whether or not the storage apparatus is electrically coupled to the processing module.

If the processing module detects that the storage apparatus is not electrically coupled to the processing module, the process of decrypting the encrypted digital data according to decryption key to obtain and provide digital data will not take place.

Compared with the foregoing preferred embodiment, this preferred embodiment further comprises the following steps:

(S321) Use the processing module to examine whether or not the storage apparatus is authenticated by a challenge-response protocol through a firmware.

If the storage apparatus is not authenticated, then the processing module will not decrypt the encrypted digital data according to the decryption key to obtain and provide digital data.

In some preferred embodiments, processing module issues an 8-byte testing code (such as 0x3132333435363738) by the firmware of the storage apparatus in the step (S321), and the firmware divides the testing code into a first 4-byte code (0x31323334) and a second 4-byte code (0x35363738). The firmware further divides the first 4-byte code into a first 2-byte code (0x3132) and a second 2-byte code (0x3334), and the firmware also processes the first and second 2-byte codes and by a SO algorithm or XOR algorithm to obtain a 2-byte code (such as 0x0206). The firmware further divides the 2-byte code into two (0x02 and 0x06), and multiples the first code by 8 and adds the result to the number (0x16) obtained from the second code. A random number table stored in the storage apparatus is looked up to find four consecutive codes after the corresponding position are taken (if ebdc is looked up, then it will be converted into 0x65626463), and this code and the first 4-byte code (0x31323334) go through the SO algorithm or XOR algorithm to obtain an output of a first 4-byte code (such as 0x54505757). In addition, the second 4-byte code are processed similarly to obtain an output of a second 4-byte code (such as 0x55060e00), and the firmware outputs the first and second 4-byte codes and combines them into an 8-byte code (such as 0x5450575755060e00) to be returned to the processing module for the authentication. After the processing module confirms that the returned 8-byte code is correct, the processing module will decrypt the encrypted data by the decryption key and store the encrypted digital data into the storage apparatus in order to obtain the digital contents. It is noteworthy to point out that the authentication method disclosed above is provided as an example for illustrating the present invention only, but not intended for limiting the invention, so that modifications and variations could be made by persons ordinarily skilled in the art without departing from the spirit of the present invention.

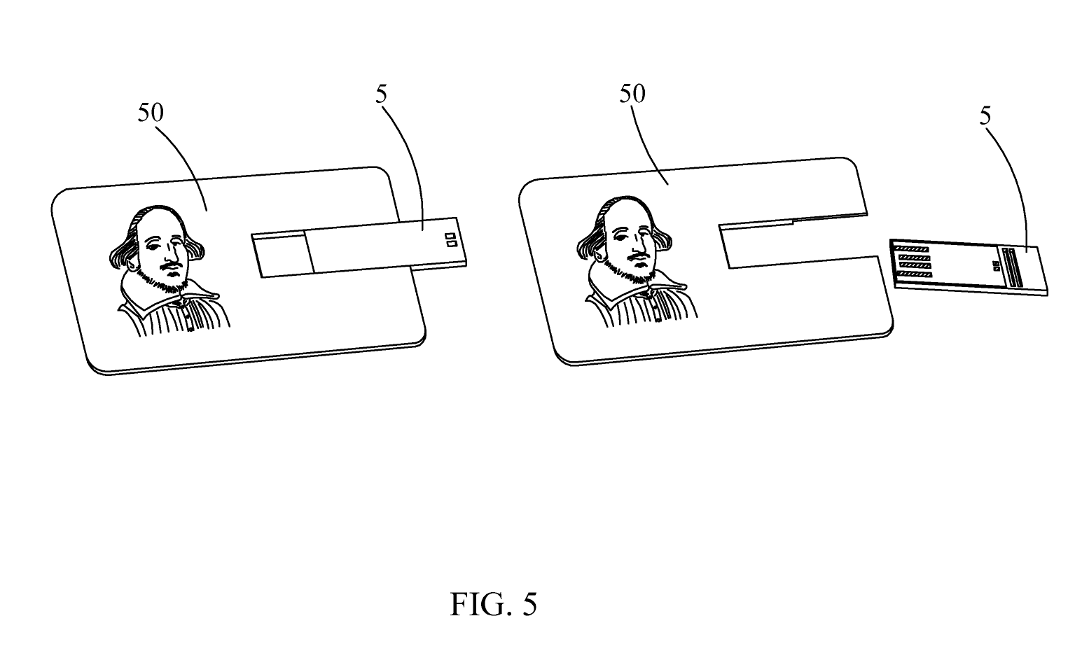

With reference to FIG. 5 for a schematic view of a storage apparatus in accordance with the present invention, the storage apparatus 5 of the present invention is provided for storing the foregoing encrypted digital data. After the storage apparatus 5 reads encrypted digital data and a unique identifier (UID) of the storage apparatus by a processing module, the processing module generates a group ID according to the UID, and then generates a decryption key according to the group ID, and encrypts encrypted digital data according to a decryption key to obtain and provide digital data. Wherein, the related encryption and decryption mentioned in the storage apparatus 5 of the present invention have been described above, and thus will not be described again.

The storage apparatus 5 of the present invention includes a USB flash together with a package 50 for showing the contents of an eBook. In this preferred embodiment, the Shakespeare's Complete Works is used as an example of the package 50, and the storage apparatus 5 can read the content of the Shakespeare's Complete Works from a side of the storage apparatus. However, the persons ordinarily skilled in the art should understand that a USB flash card used as the storage apparatus 5 of this preferred embodiment can be substituted by a CD, a DVD, a MD, a floppy disk, a memory card or any other storage apparatus that can carry and load the encrypted digital data readable by the processing module and the UID, but the present invention is not limited to these storage apparatuses only. The main point is that the storage apparatus 5 must include a UID. In addition, the storage apparatus 5 of the present invention can selectively load an operating system or any other application program.

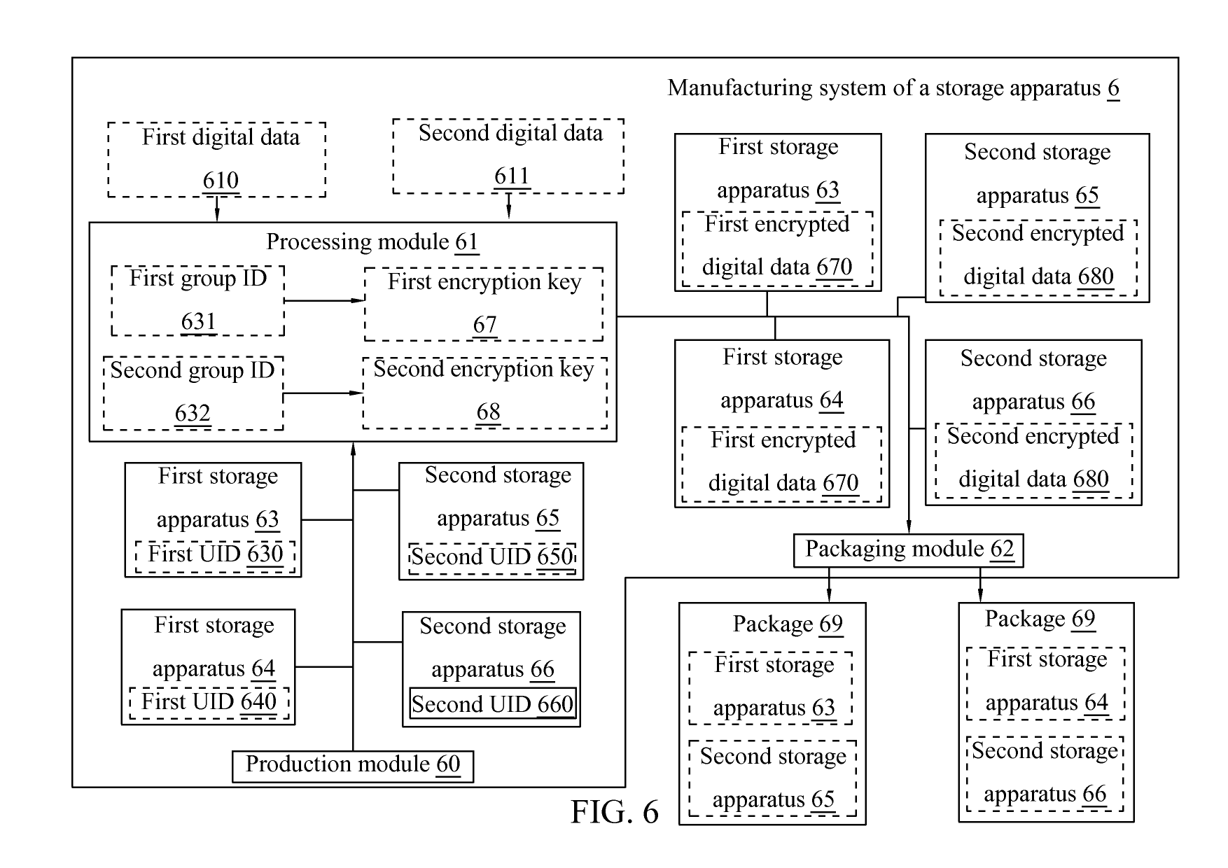

With reference to FIG. 6 for a block diagram of a manufacturing system of a storage apparatus in accordance with the present invention, the manufacturing system 6 comprises a production module 60, a processing module 61 and a packaging module 62. The production module 60 provides a plurality of first storage apparatuses 63, 64, and each first storage apparatus 63, 64 has a different first UID 630, 640, and the production module further provides a plurality of second storage apparatuses 65, 66, and each second storage apparatus 65, 66 has a different second UID 650, 660.

Wherein, the processing module 61 generates a first group ID 631 according to each different first UID 630, 640, and then generates a first encryption key 67 according to the first group ID 631. The processing module 61 further generates a second group ID 632 according to each different second UID 650, 660, and then generates a second encryption key 68 according to second group ID 632. The processing module 61 further encrypts first digital data 610 according to the first encryption key 67 to generate first encrypted digital data 670, and stores the first encrypted digital data 670 into the first storage apparatus 63, 64. The processing module 61 further encrypts second digital data 611 according to the second encryption key 68 to generate second encrypted digital data 680, and then stores the second encrypted digital data 680 into the second storage apparatus 65, 66. In this preferred embodiment, the processing module 61 generates a first encryption key 67 and a second encryption key 68 by a hash algorithm (HASH), a message-digest algorithm (MD5) or a secure hash algorithm (SHA1).

Finally, the packaging module 62 packages each first storage apparatus 63, 64 and each second storage apparatus 65, 66 into the a plurality of packages 69 randomly, and the packaging module 62 disperses and packages each first storage apparatus 63, 64 and each second storage apparatus 65, 66 into the plurality of packages 69 by a shuffle method.

Wherein, the processing module sets a portion of the UID as the group ID. However, the actual implementation is not limited to such arrangement only. In some preferred embodiments, the processing module can form the group ID according to certain digits such as the odd digits or even digits of the UID or different algorithms of the UID, and the storage apparatus is classified by the group ID. Therefore, each package 69 will have less chance of having the same key. In a certain batch of production of the storage apparatus, the encrypted digital data stored in the storage apparatus and the required decryption key may be the same, but after they are loaded into different packaging bodies 69 and sent to different points of sale, the chance for the same person to receive the same key can be reduced significantly, so as to reduce the manufacturing time and cost effectively.

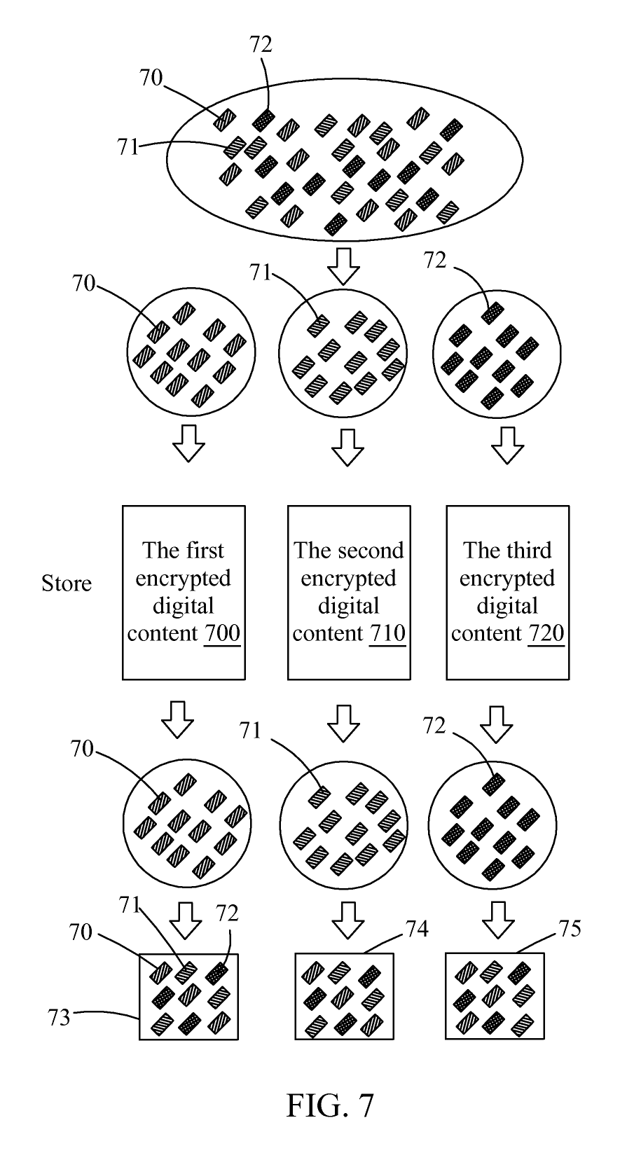

With reference to FIG. 7 for a schematic view of a manufacturing system of a storage apparatus in accordance a preferred embodiment with the present invention, the storage apparatus comprises a plurality of first storage apparatuses 70, a plurality of second storage apparatuses 71 and a plurality of third storage apparatuses 72, wherein each first storage apparatus 70 has a first UID with the same portion, and each second storage apparatus 71 has a second UID with the same portion, and each third storage apparatus 72 has a third UID with the same portion. According to the aforementioned method, the storage apparatus having a UID with the same portion will compile and store the encrypted digital contents encrypted by the same key. For example, the first storage apparatuses 70 are provided for storing the first encrypted digital content 700, the second storage apparatuses 71 are provided for storing the second encrypted digital content 710, and the third storage apparatuses 72 are provided for storing the third encrypted digital content 720. An allocation module is provided for allocate or shuffle the foregoing stored encrypted content of the storage apparatus to different packages 73, 74, 75. As indicated by the bottom of the figure, the first storage apparatus 70, second storage apparatus 71 and third storage apparatus 72 are mixed into each package so as to reduce the chance for the same person to obtain the same key and prevent an unauthorized copy of the digital contents effectively.

Even though the description of the manufacturing system of the storage apparatus in accordance with the present invention has elaborated the concept of the manufacturing method of the storage apparatus in accordance with the present invention, another flow chart is provided for illustrating the idea in details.

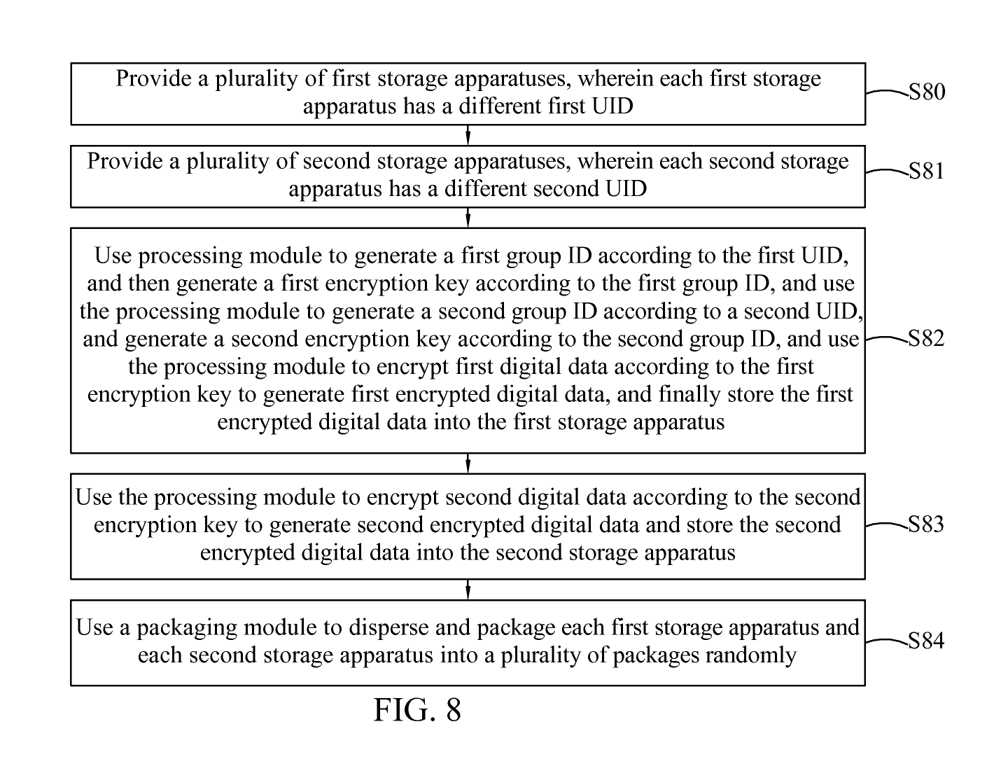

With reference to FIG. 8 for a flow chart of the manufacturing method of the storage apparatus in accordance with the present invention, the manufacturing method comprises the steps of:

(S80) providing a plurality of first storage apparatuses, wherein each first storage apparatus has a different first UID;

(S81) providing a plurality of second storage apparatuses, wherein each second storage apparatus has a different second UID;

(S82) using a processing module to generate a first group ID according to the first UID, and then generate a first encryption key according to the first group ID, and using the processing module to generate a second group ID according to a second UID, and generate a second encryption key according to the second group ID, and using the processing module to encrypt first digital data according to the first encryption key to generate first encrypted digital data, and finally storing the first encrypted digital data into the first storage apparatus;

(S83) using the processing module to encrypt second digital data according to the second encryption key to generate second encrypted digital data and store the second encrypted digital data into the second storage apparatus; and

(S84) using a packaging module to disperse and package each first storage apparatus and each second storage apparatus into a plurality of packages randomly.

Wherein, the processing module generates a first encryption key and a second encryption key by a hash algorithm (HASH), a message-digest algorithm (MD5) or a secure hash algorithm (SHA1), and the packaging module disperses and packages each first storage apparatus and each second storage apparatus into a plurality of packages by a shuffle method.

The detailed description and implementation method of the manufacturing method of the storage apparatus in accordance with the present invention have been described in the section of the encryption method of digital data, the decryption method of encrypted digital data, and the manufacturing system of the storage apparatus, and thus will not be described again.

In summation, the user's convenience is taken into consideration, and the present invention provides a portable device for producing mass data as a carrier for the protection of digital data, and content provider can use the portable device as a container (such as a USB flash) to sell the digital contents, so as to replace paper books and achieve the effect of protecting the contents. Users can connect this device to a computer, or read digital contents from this device. Since the digital contents are protected by this device, any digital contents copied and distributed to another device or computer will be unreadable.

What is claimed is:

1. An encryption method of digital data, comprising the steps of:
providing the digital data;
reading a unique identifier (UID) of a storage apparatus by a processing module, and generating a group ID according to the UID;
generating an encryption key according to the group ID by the processing module;
encrypting the digital data according to the encryption key by the processing module to generate encrypted digital data; and
storing the encrypted digital data in the storage apparatus.

2. The encryption method of digital data as recited in claim 1, wherein the processing module generates the encryption key by a hash algorithm, a message-digest algorithm (MD5) or a secure hash algorithm (SHA1).

3. A decryption method of encrypted digital data, comprising the steps of:
reading encrypted digital data in a storage apparatus by a processing module, and the encrypted digital data being encrypted by the encryption method as recited in claim 1;
reading a UID of the storage apparatus by the processing module, and generating a group ID according to the UID;
generating a decryption key by the processing module according to the group ID; and
decrypting the encrypted digital data according to the decryption key by the processing module to obtain and provide digital data.

4. The decryption method of encrypted digital data as recited in claim 3, wherein the processing module generates the decryption key by a hash algorithm, a message-digest algorithm (MD5) or a secure hash algorithm (SHA1).

5. The decryption method of encrypted digital data as recited in claim 3, further comprising the steps of:
using the processing module to detect whether or not the storage apparatus is electrically coupled to the processing module; and
if the processing module detects that the storage apparatus is not electrically coupled to the processing module, the processing module will not decrypt the encrypted digital data according to the decryption key to obtain and provide the digital data.

6. The decryption method of encrypted digital data as recited in claim 4, further comprising the steps of:
using the processing module to detect whether or not the storage apparatus is electrically coupled to the processing module; and
if the processing module detects that the storage apparatus is not electrically coupled to the processing module, the processing module will not decrypt the encrypted digital data according to the decryption key to obtain and provide the digital data.

7. The decryption method of encrypted digital data as recited in claim 3, further comprising the steps of:
using the processing module to examine whether or not the storage apparatus is authenticated by a challenge-response protocol through a firmware of the storage apparatus; and
if the storage apparatus is not authenticated, the processing module will not decrypt the encrypted digital data according to the decryption key to obtain and provide the digital data.

8. The decryption method of encrypted digital data as recited in claim 4, further comprising the steps of:
using the processing module to examine whether or not the storage apparatus is authenticated by a challenge-response protocol through a firmware of the storage apparatus; and
if the storage apparatus is not authenticated, the processing module will not decrypt the encrypted digital data according to the decryption key to obtain and provide the digital data.

9. A storage apparatus, for storing the encrypted digital data as recited in claim 1, and the storage apparatus using a processing module to read a unique identifier (UID) of the encrypted digital data and the storage apparatus, and the processing module generating a group ID according to the UID, and then generating a decryption key according to the group ID, and decrypting the encrypted digital data according to the decryption key to obtain and provide digital data.

10. The storage apparatus of claim 9, wherein the processing module generates the decryption key by a hash algorithm (HASH), a message-digest algorithm (MD5) or a secure hash algorithm (SHA1).

11. The storage apparatus of claim 9, wherein the processing module further detects whether or not the storage apparatus is electrically coupled to the processing module, and if the processing module detects that the storage apparatus is not electrically coupled to the processing module, the processing module will not decrypt the encrypted digital data according to the decryption key to obtain and provide the digital data.

12. The storage apparatus of claim 9, wherein the processing module further examines whether or not the storage apparatus is authenticated by a challenge-response protocol through a firmware of the storage apparatus; and if the storage apparatus is not authenticated, the processing module will not decrypt the encrypted digital data according to the decryption key to obtain and provide the digital data.

13. A storage apparatus, for storing the encrypted digital data as recited in claim 2, and the storage apparatus using a processing module to read a unique identifier (UID) of the encrypted digital data and the storage apparatus, and the processing module generating a group ID according to the UID, and then generating a decryption key according to the group ID, and decrypting the encrypted digital data according to the decryption key to obtain and provide digital data.

14. The storage apparatus of claim 13, wherein the processing module further detects whether or not the storage apparatus is electrically coupled to the processing module, and if the processing module detects that the storage apparatus is not electrically coupled to the processing module, the processing module will not decrypt the encrypted digital data according to the decryption key to obtain and provide the digital data.

15. The storage apparatus of claim 13, wherein the processing module further examines whether or not the storage apparatus is authenticated by a challenge-response protocol through a firmware of the storage apparatus; and if the storage apparatus is not authenticated, the processing module will not decrypt the encrypted digital data according to the decryption key to obtain and provide the digital data.

16. A manufacturing method of a storage apparatus, comprising the steps of:
providing a plurality of first storage apparatuses, each of the first storage apparatuses having a different first UID;
providing a plurality of second storage apparatuses, each of the second storage apparatuses having a different second UID;
generating a first group ID according to the first UIDs by a processing module, and then generating a first encryption key according to the first group ID;
using the processing module to generate a second group ID according to the second UIDs, and generating a second encryption key according to the second group ID;
using the processing module to encrypt first digital data according to the first encryption key to generate first encrypted digital data;
storing the first encrypted digital data into the first storage apparatuses;
using the processing module to encrypt a second digital data according to the second encryption key to generate second encrypted digital data;
storing the second encrypted digital data into the second storage apparatuses; and
using a packaging module to package each first storage apparatus and each second storage apparatus randomly into a plurality of packages.

17. The manufacturing method of a storage apparatus as recited in claim 16, wherein the processing module generates the first encryption key and the second encryption key by a hash algorithm (HASH), a message-digest algorithm (MD5) or a secure hash algorithm (SHA1).

18. The manufacturing method of a storage apparatus as recited in claim 16, wherein the packaging module packages each of the first storage apparatuses and each of the second storage apparatuses into a plurality of packages by a shuffle method.

19. A manufacturing system of a storage apparatus, comprising:
a production module, for providing a plurality of first storage apparatuses, and each of the first storage apparatuses having a different first UID, and the production module further providing a plurality of second storage apparatuses, and each of the second storage apparatuses having a different second UID;
a processing module, for generating a first group ID according to the first UIDs, and then generating a first encryption key according to the first group ID, and generating a second group ID according to the second UIDs, and then generating a second encryption key according to the second group ID, and then encrypting first digital data according to the first encryption key to generate first encrypted digital data, and storing the first encrypted digital data into the first storage apparatuses, and further encrypting second digital data according to the second encryption key to generate a second encrypted digital data, and storing the second encrypted digital data into the second storage apparatuses; and
a packaging module, for dispersing and assembling each of the first storage apparatuses and each the second storage apparatuses randomly into the plurality of packages.

20. The manufacturing system of a storage apparatus as recited in claim 19, wherein the processing module generates the first encryption key and the second encryption key by a hash algorithm, a message-digest algorithm (MD5) or a secure hash algorithm (SHA1).

21. The manufacturing system of a storage apparatus as recited in claim 19, wherein the packaging module packages each of the first storage apparatuses and each of the second storage apparatuses is packaged into a plurality of packages by a shuffle method.
